(19) United States
(12) Patent Application Publication
(10) Pub. No.: US 2026/0146943 A1
(43) Pub. Date: May 28, 2026

(54) METHOD FOR DETECTING AND REMOVING MOTION ARTIFACT OF FUNCTIONAL NEAR-INFRARED SPECTROSCOPY SIGNAL

(71) Applicant: KOREA UNIVERSITY RESEARCH AND BUSINESS FOUNDATION, Seoul (KR)

(72) Inventors: Eun-jeong CHOI, Seoul (KR); Seung Hyun LEE, Seoul (KR); Seung Ho PAIK, Seoul (KR); Beop-min KIM, Seoul (KR); Zephaniah PHILLIPS, Seoul (KR)

(21) Appl. No.: 19/122,785

(22) PCT Filed: Oct. 10, 2023
(86) PCT No.: PCT/KR2023/015478

§ 371 Date: Apr. 21, 2025

(30) Foreign Application Priority Data
Oct. 21, 2022 (KR) 10-2022-0136404

(51) Int. Cl. G01N 21/359; G06N 3/0464; G06N 3/09

(52) U.S. Cl. CPC G01N 21/359; G06N 3/0464; G06N 3/09; G01N 2201/1296

(57) ABSTRACT

The present invention relates to a method for detecting and removing a motion artifact of a functional near-infrared spectroscopy signal. Disclosed are a method and a device for detecting and removing a motion artifact of a near-infrared spectroscopy signal in real time on the basis of an artificial neural network model, the method comprising: a conversion step of converting time series data of functional near-infrared spectroscopy signals measured through a plurality of channels from a target into image data; a detection step of detecting whether noise is present in the converted image data using a pretrained detection model; and a removal step of removing noise from image data where noise has been detected using a pretrained noise removal model.

### TECHNICAL FIELD

The disclosure was carried out with the support of the Ministry of Science and ICT under the unique project number 1711174377 and project number KMDF-RS-2022-00140478. The research management specialized institution for the project is the Korea Medical Device Development Fund (KMDF), the research project is titled “Implementation of Medical Public Welfare and Resolution of Social Issues (2022),” the research task is titled “Development of an AI-Based Personalized Optimal Rehabilitation Multimodal Neurostimulation Treatment Device,” the main institution is Korea University, and the research period is from Apr. 1, 2022 to Dec. 31, 2025.

The disclosure was also carried out with the support of the Ministry of Health and Welfare under the unique project number 1465036228 and project number HI14C3477. The research management specialized institution for the project is the Korea Health Industry Development Institute (KHIDI), the research project is titled “Health and Medical Technology R&D Program,” the research task is titled “Study on Brain Hemodynamic Oxygen Saturation Measurement Based on Optical Technology and Development of Brain Function Diagnostic Equipment,” the main institution is Korea University, and the research period is from Dec. 1, 2014 to Jan. 10, 2023.

The disclosure relates to a method for detecting and removing a motion artifact of a functional near-infrared spectroscopy (fNIRS) signal. More specifically, the method includes converting a fNIRS signal represented as time series data into an image and detecting a motion artifact of the fNIRS signal from the converted image by using an artificial neural network model.

### BACKGROUND ART

With the advancement of electronic technologies, research and development have been conducted on medical devices incorporating various electronic techniques. To non-invasively acquire bio-information from inside the human body, particularly the brain, equipment such as electroencephalogram (EEG), computed tomography (CT), and magnetic resonance imaging (MRI) are commonly utilized.

Recently, research on functional near-infrared spectroscopy (fNIRS) has been actively conducted along with various devices for acquiring brain bio-information. Functional near-infrared spectroscopy (fNIRS) is a method that allows visualization of human tissue using harmless light, and has the advantage of minimizing costs compared to other methods. Functional near-infrared spectroscopy is a non-invasive method for measuring the concentration changes and optical coefficients of absorptive substances such as oxyhemoglobin, deoxyhemoglobin, and myoglobin present in human tissues. The near-infrared light in the 700-2800 nm band, particularly in the 700-900 nm band, has relatively lower and absorption in human tissues compared to other wavelength bands. This allows the light to penetrate deeper and enables the acquisition of information from depths of several centimeters inside the human body. Absorptive substances present in the human body may be largely categorized into oxygen-dependent and oxygen-independent substances. Particularly, changes in the concentration of oxygen-dependent substances are closely related to metabolic activity in the human body, and it is therefore very important to analyze the substances quantitatively and qualitatively.

When using functional near-infrared spectroscopy, it is possible to measure brain states in real time during various activities, as such cognition and motor activities, but a motion artifact, which is an abnormal signal spike, caused by horizontal or vertical displacement of optodes due to head or torso movement, may occur. When a motion artifact occurs, it is difficult to obtain a reliable hemodynamic brain signal containing neurophysiological information by using functional near-infrared spectroscopy.

Therefore, an effective motion artifact removal method is required to obtain reliable brain activity signals.

### DISCLOSURE OF INVENTION

### Technical Problem

Accordingly, the inventors of the disclosure have developed a method for detecting and removing motion artifacts of functional near-infrared spectroscopy signal (fNIRS), based on an artificial neural network model, and have confirmed that the performance thereof in motion artifact detection and removal is significantly superior.

Accordingly, an aspect of the disclosure is to provide a method for removing a motion artifact of a functional near-infrared spectroscopy signal.

Another aspect of the disclosure is to provide a computer program for removing a motion artifact of a functional near-infrared spectroscopy signal.

Yet another aspect of the disclosure is to provide a computing device for removing a motion artifact of a functional near-infrared spectroscopy signal.

### Solution to Problem

The disclosure relates to a method for detecting and removing a motion artifact of a functional near-infrared spectroscopy signal. The method according to the disclosure may detect and remove a motion artifact of a functional near-infrared spectroscopy signal in real time, based on an artificial neural network model.

The disclosure will be described in more detail below.

According to one aspect of the disclosure, a method for removing, by a computing device, a motion artifact of a functional near-infrared spectroscopy (fNIRS) signal, includes a conversion step of converting time series data of a functional near-infrared spectroscopy signal measured from a subject via a plurality of channels into image data, a detection step of determining, using a pretrained detection model, whether noise is present in the converted image data, and a removal step of removing, using a pretrained noise removal model, noise from the image data in which noise has been detected.

The term “motion artifact” as used in the specification refers to abnormal signal spikes caused by horizontal or vertical displacement of fNIRS optodes in a functional near-infrared spectroscopy system. Motion artifacts hinder the interpretation of hemodynamic changes that are expected due to neurovascular coupling. TO address this issue, techniques such as spline interpolation, PCA, and wavelet filtering have been used. However, certain motion artifacts are not eliminated by individual filtering methods, and meaningful signals may be unnecessarily filtered out due to the frequency bands which are removed when multiple filtering techniques are combined.

The term “subject” as used in the specification may refer to an object (or specimen) to be measured using functional near-infrared spectroscopy signals. In an embodiment of the disclosure, the subject may be a mammal, and for example, the subject may be one or more selected from the group consisting of humans, monkeys, dogs, cats, mice, rats, cattle, horses, pigs, goats, and sheep.

In an embodiment of the disclosure, the detection model and/or the noise removal model may be a deep neural network (DNN) model.

The term “deep neural network” as used in the specification may refer to a neural network that includes multiple hidden layers in addition to an input layer and an output layer. The term “deep neural network” may be used interchangeably throughout the specification with the terms “neural network,” “network function,” and “neural network (NN).” A deep neural network enables the identification of latent structures in data. That is, the deep neural network enables the identification of latent structures in photos, text, videos, voices, and music (e.g., what an object is in the photo, what is the content and emotion of the text, what is the content and emotion of the voice, etc.). In the disclosure, the deep neural network may include, but is not a limited to, (CNN), a recurrent neural convolutional neural network network (RNN), a restricted Boltzmann machine (RBM), a deep belief network (DBN), a Q-network, a U-network, or a Siamese network.

In an embodiment of the disclosure, the conversion step may include a coordinate conversion step of converting time series data into polar coordinates according to Equation 1 below.

$$\begin{matrix}{ϕ}_{i} = arccos ( {x}_{i} ) \\ {r}_{i} = \frac{i}{N}\end{matrix} \qquad [ Equation 1 ]$$

wherein N denotes the number of timestamps in time series data, and xᵢ represents the functional near-infrared spectroscopy signal value at a specific timestamp i.

In an embodiment of the disclosure, the conversion step may include a gramian angular summation field (GASF) image generation step of by converting time series data into a GASF image according to Equation 2 below to thereby convert the time series data into image data.

$$G = ( \begin{matrix}cos ( {ϕ}_{1} + {ϕ}_{1} ) & cos ( {ϕ}_{1} + {ϕ}_{2} ) & ⋯ & cos ( {ϕ}_{1} + {ϕ}_{n} ) \\ cos ( {ϕ}_{2} + {ϕ}_{1} ) & cos ( {ϕ}_{2} + {ϕ}_{2} ) & ⋯ & cos ( {ϕ}_{2} + {ϕ}_{n} ) \\ ⋮ & ⋮ & ⋱ & ⋮ \\ cos ( {ϕ}_{n} + {ϕ}_{1} ) & cos ( {ϕ}_{n} + {ϕ}_{2} ) & ⋯ & cos ( {ϕ}_{n} + {ϕ}_{n} )\end{matrix} ) \qquad [ Equation 2 ]$$

wherein φᵢ is the arccosine value of the functional near-infrared spectroscopy (fNIRS) signal value at a specific timestamp i.

In an embodiment of the disclosure, the detection step may include a classification step of classifying the type of noise from the converted image data.

In an embodiment of the disclosure, the classification step may include classifying the type of noise from the converted image data as a spike and a baseline shift.

In an embodiment of the disclosure, the method may include a normalization step of normalizing time series data of the functional near-infrared spectroscopy signal.

In an embodiment of the disclosure, the normalization step may include normalizing the signal of the time series data to a range between −1 and 1.

In an embodiment of the disclosure, the removal step may include a reconstruction step of reconstructing time series data from the image data from which noise has been removed.

In an embodiment of the disclosure, the removal step may include a selection step of selecting, via the pretrained noise removal model, a removal filter according to the type of noise from the image data in which noise has been detected.

In an embodiment of the disclosure, the detection model and/or the noise removal model may be subjected to supervised training based on at least one training image and a guide label, which corresponds to the training image and includes a noise determination result.

In an embodiment of the disclosure, the supervised training may be performed based on a result of comparing the guide label with training information generated for the training image by using the detection model and/or the noise removal model.

In an embodiment of the disclosure, the detection model and/or the noise removal model may be subjected to supervised training based on at least one training image and a guide label, which corresponds to the training image and includes a noise determination result, and the supervised training may be performed based on a result of comparing the guide label with training information generated for the training image by using the detection model and/or the noise removal model.

In an embodiment of the disclosure, the supervised training may be performed based on a result value calculated by substituting the training information and the guide label into a binary cross-entropy loss function.

In an embodiment of the disclosure, the detection step may include a comparison step of detecting noise by comparing image data respectively converted from time series data measured by adjacent channels.

Another aspect of the disclosure is to provide a computer program stored in a storage medium, wherein the computer program, when executed on one or more processors, causes the following operations for removing a motion artifact of a functional near-infrared spectroscopy (fNIRS) signal to be performed, the operations including a conversion operation of converting time series data of a measured functional near-infrared spectroscopy signal into image data, a detection operation of determining whether noise is present in the converted image data using a pretrained detection model, and a removal operation of removing, using a pretrained noise removal model, noise from image data in which noise has been detected.

Another aspect of the disclosure is to provide a computing device for removing motion artifacts of a functional near-infrared spectroscopy (fNIRS) signal, the computing device including a processor including one or more cores, and a memory, wherein the processor is configured to convert time series data of a measured functional near-infrared spectroscopy signal into image data, determine whether noise is present in the converted image data using a pretrained detection model, and remove, using a pretrained noise removal model, noise from the image data in which noise has been detected.

### Advantageous Effects of Invention

The disclosure relates to a method for detecting and removing a motion artifact of a functional near-infrared spectroscopy signal. The method according to the disclosure can obtain a near-infrared spectroscopy signal that reliably reflects the state information of a subject in various environments, and thus can be used as software and hardware for medical imaging devices, and can also be utilized in the field of brain-computer interfaces.

### BRIEF DESCRIPTION OF DRAWINGS

FIG. 1 is a block diagram of a computing device that performs an operation for removing motion artifacts of a functional near-infrared spectroscopy (fNIRS) signal according to an embodiment of the disclosure.

FIG. 2 is a schematic diagram showing a deep neural network according to an embodiment of the disclosure.

FIG. 3 is a block diagram illustrating a process for removing a motion artifact of a functional near-infrared spectroscopy signal according to an embodiment of the disclosure.

FIG. 4 is a graph showing, as a measured near-infrared spectroscopy signal according to an embodiment of the disclosure, time series data including spike and baseline shift noises.

FIG. 5 is a diagram showing the result of converting time series data including spike and baseline shift noises into polar coordinates according to an embodiment of the disclosure.

FIG. 6 is a diagram showing the result of converting time series data including spike and baseline shift noises into a gramian angular summation field (GASF) image according to an embodiment of the disclosure.

FIG. 7 is a diagram for explaining a process of removing noise from image data according to an embodiment of the disclosure.

FIG. 8 is a diagram showing a GASF image from which noise has been removed according to an embodiment of the disclosure.

FIG. 9 is a graph showing time series data of a near-infrared spectroscopy signal including noise.

FIG. 10 is a graph showing the result of removing noise from the time series data of FIG. 9 by using an existing method.

FIG. 11 is a graph showing the result of removing noise from the time series data of FIG. 9 by using a method according to an embodiment of the disclosure.

### BEST MODE FOR CARRYING OUT THE INVENTION

Provided is a method for removing, by a computing device, a motion artifact of a functional near-infrared spectroscopy (fNIRS) signal, the method including
a conversion step of converting time series data of a functional near-infrared spectroscopy signal measured from a subject via multiple channels into image data,
a detection step of determining, using a pretrained detection model, whether noise is present in the converted image data, and
a removal step of removing, using a pretrained noise removal model, noise from the image data in which noise has been detected.

Hereinafter, embodiments of the disclosure will be described in detail with reference to the accompanying drawings so that those skilled in the art may easily implement the invention. However, the disclosure may be implemented in various different forms and is not limited to the embodiments described herein. In the drawings, parts that are not related to the description are omitted, and similar drawing reference numerals are used for similar parts throughout the specification.

Throughout the specification, when a part is described as “including” a certain component, this does not mean that other components are excluded, but that other components can be further included, unless otherwise specifically stated. The terms “and/or” include all combinations and any one of the items listed in relation thereto.

In addition, the terms “ . . . part” and “ . . . module” described in the specification refer to a unit that processes at least one function or operation, which may be implemented by hardware or software, or a combination of hardware and software.

It should be appreciated that the various illustrative logical blocks, configurations, modules, circuits, means, logics, and algorithm steps described in connection with the embodiments herein may be implemented as electronic hardware, computer software, or a combination thereof. To clearly illustrate the interchangeability of hardware and software, various illustrative components, blocks, configurations, means, logics, modules, circuits, and steps have been generally described above in terms of their functionality. Whether such functionality is implemented as hardware or software depends on the specific application and design constraints imposed on the overall system. Skilled artisans may implement the described functionality in various ways for each particular application. However, such implementation decisions should not be interpreted as departing from the scope of the disclosure.

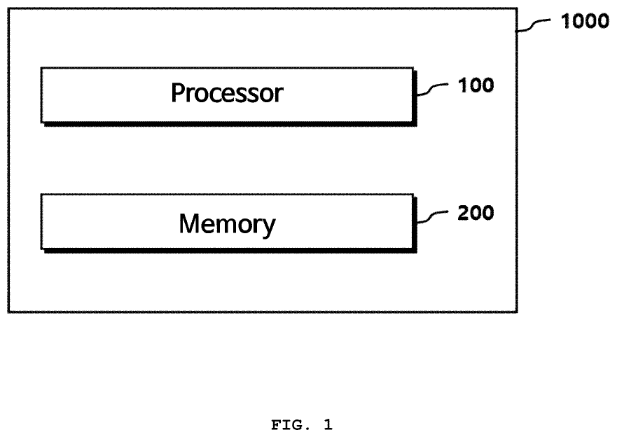

FIG. 1 is a block diagram of a computing device that performs an operation for removing motion artifacts of a functional near-infrared spectroscopy (fNIRS) signal according to an embodiment of the disclosure.

Referring to FIG. 1, a computing device 1000 that performs an operation for removing motion artifacts of a functional near-infrared spectroscopy signal according to an embodiment may include a processor 100 and a memory 200.

The processor 100 may perform operations of converting time series data of a functional near-infrared spectroscopy signal measured from a subject via multiple channels into image data, determining, using a pretrained detection model, whether noise is present in the converted image data, and removing, using a pretrained noise removal model, noise from the image data in which noise has been detected.

The processor 100 may perform, when converting time series data of functional near-infrared spectroscopy signals measured from a subject via multiple channels into image data, an operation of converting the time series data into polar coordinates. For example, the processor may perform an operation of converting the time series data into polar coordinates according to Equation 1 below.

$$\begin{matrix}{ϕ}_{i} = arccos ( {x}_{i} ) \\ {r}_{i} = \frac{i}{N}\end{matrix} \qquad [ Equation 1 ]$$

wherein N denotes the number of timestamps in time series data, and xᵢ represents the functional near-infrared spectroscopy signal value at a specific timestamp i.

When the processor 100 converts the time series data of functional near-infrared spectroscopy signals into polar coordinates, the near-infrared spectroscopy signals measured on the time series data may be expressed as a radius (r) and an angle on a polar coordinate system, and the near-infrared spectroscopy signal value expressed in polar coordinate form based thereon may be converted into a gramian angular summation field (GASF) image to be described later. At this time, since the radius in polar coordinates is calculated based on a timestamp of the time series data, polar the coordinate system may simultaneously include time information and near-infrared spectroscopy signal value information, just as in the time series data.

The processor 100 may perform, when converting time series data of functional I spectroscopy signals measured from a subject via multiple channels into image data, an operation of converting time series data into a gramian angular summation field (GASF) image according to Equation 2 below to thereby convert the time series data into image data.

$$G = ( \begin{matrix}cos ( {ϕ}_{1} + {ϕ}_{1} ) & cos ( {ϕ}_{1} + {ϕ}_{2} ) & ⋯ & cos ( {ϕ}_{1} + {ϕ}_{n} ) \\ cos ( {ϕ}_{2} + {ϕ}_{1} ) & cos ( {ϕ}_{2} + {ϕ}_{2} ) & ⋯ & cos ( {ϕ}_{2} + {ϕ}_{n} ) \\ ⋮ & ⋮ & ⋱ & ⋮ \\ cos ( {ϕ}_{n} + {ϕ}_{1} ) & cos ( {ϕ}_{n} + {ϕ}_{2} ) & ⋯ & cos ( {ϕ}_{n} + {ϕ}_{n} )\end{matrix} ) \qquad [ Equation 2 ]$$

wherein φᵢ is the arccosine value of the functional near-infrared spectroscopy (fNIRS) signal value at a specific timestamp i.

In this case, each pixel value in the image data may correspond to each element in the Gramian matrix of Equation 2. According to predetermined criteria, the numerical value of each element in the Gramian matrix may be represented in the image data using a corresponding color. As shown in the Gramian matrix of Equation 2, the elements of the matrix converted using gramian angular summation field (GASF) are expressed as the sum of angles of time series data represented in a polar coordinate system composed of time pairs. Accordingly, temporal correlations may be expressed in the matrix and, consequently, the temporal correlations may also be expressed in the converted image data. That is, the pixels on the diagonal extending from the top left to the top right of the image data represent the values of the original time series data, and the off-diagonal pixels includes signal value information measured at two or more different time points, thereby indicating temporal correlations between different time points.

The processor 100 may perform an operation of classifying the type of noise from the converted image data when determining whether noise is present in the converted image data using a pretrained detection model. At this time, the processor 100 may perform an operation of classifying the type of noise from the converted image data as a spike or a baseline shift.

The processor 100 may perform an operation of normalizing time series data of functional near-infrared spectroscopy signals. The processor 100 may perform an operation of normalizing, for example, a signal value of the time series data to a value between −1 and 1.

The processor 100 may perform an operation of generating, from the image data, image data from which noise has been removed when removing, using a pretrained noise removal model, noise from the image data in which noise has been detected.

The processor 100 may perform, when removing, using a pretrained noise removal model, noise from the image data in which noise has been detected, an operation of reconstructing time series data from the image data from which noise has been removed. Specifically, the processor 100 may generate, via the noise removal model from image data converted from time series data, image data from which noise has been removed, and may reconstruct time series data, based on the image data from which noise has been removed. As described above, the image data according to an embodiment is generated based on a Gramian matrix such as that of Equation 2. Since the main diagonal of the image data represents a signal value at specific time point, similar to the time series data, the processor 100 may reconstruct time series data from the image data, based on the signal value.

The processor 100 may perform, when removing, using the pretrained noise removal model, noise from the image data in which noise has been detected, an operation of selecting, via the pretrained noise removal model, a removal filter according to the type of noise from the image data in which noise has been detected. For example, the processor 100 may select a filter, such as a Gaussian filter, a Kalman filter, or an adaptive noise removal filter via the noise removal model according to the type of noise from the image data in which noise has been detected, and may generate image data from the noise-removed image data by using the filter.

When the processor 100 performs an operation for removing noise of functional near-infrared spectroscopy signals, the processor 100 may utilize time series data of the functional near-infrared spectroscopy signals measured via multiple channels. That is, the time series data of the measured near-infrared spectroscopy signal may include data measured via channels different from each other.

In addition, when the processor 100 performs an operation of removing noise from the image data in which noise has been detected, the processor 100 may perform an operation of detecting noise by comparing image data respectively converted from time series data measured by adjacent channels. As described above, a temporal correlation is expressed on the image data converted from time series data, and the presence or absence of motion artifacts may be determined by comparing the pixel values of the image data converted from the time series data obtained from the respective channels. For example, when functional near-infrared spectroscopy signals are measured via three adjacent channels to form three time series datasets, the three time series datasets may be converted into respective image data through the process described above to form three image datasets. At this time, when a specific pixel value of the converted image data, measured via one channel, is significantly different from the corresponding pixel values of the converted image data, measured via the remaining two adjacent channels, the trained detection model may determine that the motion artifacts have occurred.

Therefore, a computing device configured to perform an operation for removing motion artifacts of functional near-infrared spectroscopy signals according to an embodiment may detect and remove motion artifacts based on data measured by multiple channels and converted into image data, and thus may more accurately determine the presence or absence of motion artifacts and remove the motions artifacts. Specifically, as shown in Examples 1 and 2 below, the computing device configured to perform an operation for removing motion artifacts of functional near-infrared spectroscopy signals according to an embodiment may accurately detect and remove motion artifacts even in sections where motion artifacts are not identified by existing cutoff-based methods.

The pretrained detection model and/or noise removal model may be a deep neural network (DNN). The deep neural network may include an input layer and an output layer, or include multiple hidden layers separate from the input layer and the output layer. The deep neural network may include a convolutional neural network (CNN), a recurrent neural network (RNN), a restricted Boltzmann machine (RBM), a deep belief network (DBN), a Q network, a U network, a Siamese network, etc., and for example, the deep neural network may be a convolutional neural network.

The convolutional neural network (CNN) is a type of multilayer perceptron that may include a neural network including convolutional layers. The CNN may utilize weights during computation through the neural network. The CNN may include one or more convolutional layers and neural network layers connected thereto. The convolutional layer may extract features from input data using filters. In this case, the convolutional layer may include filters and an activation function that changes the filter into a non-linear value. The CNN may process image data by representing the same as a matrix having dimensions, and thus, the CNN may be used to recognize objects in images. For example, image data encoded in red, green, and blue may be represented as a two-dimensional matrix for each of the R, G, and B colors, that is, the color value of each pixel may be a component of the matrix, and in this case, the size of the matrix may be the same as the size of the image. The CNN may include a pooling layer, and thus enable utilization of input data having a two-dimensional structure.

The CNN may include one or more convolutional layers and sub-sampling layers. The sub-sampling layer may be connected to the output of the convolutional layer to simplify the output of the convolutional layer. For example, when the output of the convolutional layer is input to a pooling layer having a 2*2 average pooling filter, the image may be compressed by outputting the average value included in each patch for each 2*2 patch from each pixel of the image. The above-described pooling may be a method for outputting the minimum value from the patch or outputting the maximum value from the patch, and any pooling method may be used. The CNN may extract features from a given image by repeatedly performing a convolutional process and a sub-sampling process such as pooling. At this time, the output from the convolutional layer and/or the sub-sampling layer may be input to a fully connected layer. The fully connected layer is a layer in which every neuron in the layer is connected to every neuron in the adjacent layer.

The processor 100 may include one or more cores, and may include a processor for data analysis and deep learning, such as a central processing unit (CPU), a graphics processing unit (GPU), and a tensor processing unit (TPU) of the computing device. The processor may read a computer program stored in a memory and perform data processing for machine learning according to an embodiment. According to an embodiment, the processor may perform operations for training a neural network. The processor may perform operations for neural network training in deep learning (DL), including processing of input data for training, feature extraction from the input data, error calculation, and updating of neural network weights using backpropagation. At least one of the CPU, GPU, and TPU of the processor 110 may perform training of a network function.

A memory 200 may include at least one type of storage medium, such as a flash memory type, a hard disk type, a multimedia card micro type, a card-type memory (e.g., SD or XD memory), random access memory (RAM), static random access memory (SRAM), read-only memory (ROM), electrically erasable programmable read-only memory (EEPROM), programmable read-only memory (PROM), magnetic memory, magnetic disk, or optical disk.

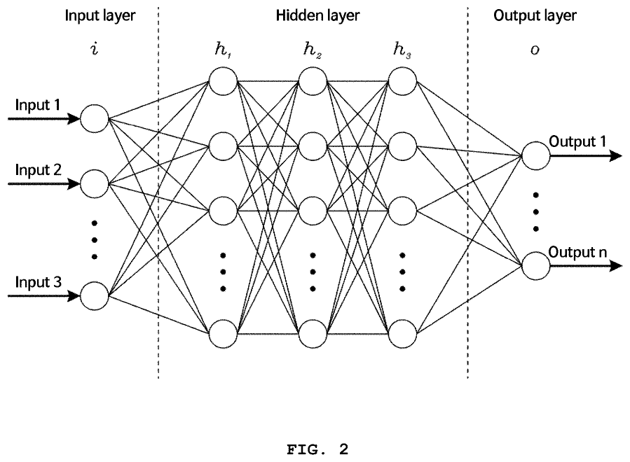

FIG. 2 is a schematic diagram showing a deep neural network according to an embodiment of the disclosure.

The neural network may represent a model of a machine learning structure designed to extract feature data from input data and provide inference operations using the feature data. At this time, the feature data may represent data regarding features abstracted from the input data. For convenience of explanation, FIG. 2 illustrates that the hidden layer includes three layers, but the hidden layer may include a variety of layers. The neural network may include one or more layers, and each layer may include one or more nodes.

A nodes (or unit) is an element that constitutes each layer, and each layer may be composed of a node or a set of nodes. In a neural network, the nodes of layers other than the output layer may be connected to the nodes of the subsequent layer via a link used to transmit output signals. In this case, the nodes of respective layers may be interconnected via a link, and the connected nodes of the layers may have an input node-output node relationship depending on whether a signal is transmitted or received. Among the nodes connected via a link, data of an output node may have a value determined according to data input to an input node. Each node included in a hidden layer may receive, as an input, the output of an activation function regarding weighted inputs of nodes included in a previous layer input. The Weighted inputs refer to the inputs of nodes included in a previous layer, to which weights are applied. At this time, the weights may be variable and may vary depending on the function and algorithm of the neural network. The weights may be referred to as parameters of the neural network, and the activation function may include a sigmoid function, a hyperbolic tangent (tanh), or a rectified linear unit (ReLU).

The initial input node may refer to one or more nodes among the nodes in the neural network that receive data directly without passing through links in the relationship with other nodes. Alternatively, within the neural network, in the relationship between nodes based on links, the initial input node may refer to nodes that do not have other input nodes connected by links. Similarly, the final output node may refer to one or more nodes among the nodes in the neural network that do not have output nodes in the relationship with other nodes. In addition, a hidden node may refer to nodes constituting the neural network that is neither an initial input node nor a final output node.

A deep neural network (DNN) may refer to a neural network that includes multiple hidden layers in addition to an input layer and an output layer. The DNN enables the identification of latent structures in data. That is, the DNN enables the identification of latent structures in photos, text, videos, voices, and music (e.g., what an object is in the photo, what is the content and emotion of the text, what is the content and emotion of the voice, etc.). The deep neural network may include a convolutional neural network (CNN), a recurrent neural network (RNN), an auto encoder, a generative adversarial network (GAN), a restricted Boltzmann machine (RBM), a deep belief network (DBN), a Q network, a U network, a Siamese network, a generative adversarial network (GAN), and the like.

A convolutional neural network (CNN) is a type of deep learning model that processes data with grid patterns, such as images, and is inspired by the structure of the visual cortex in animals. The CNN may generally include convolutional layers, pooling layers, and fully connected layers. The convolutional and pooling layers may be repeated within a neural network, and input data may be converted into output through these hierarchical layers. In the convolutional layer, for feature extraction, a kernel (or mask) is applied, and at each position, the element-wise product between the kernel elements and the input values is computed and summed to produce an output value, which is referred to as a feature map. This process may be repeated by applying multiple kernels to configure an arbitrary number of feature maps. In the convolutional neural network, the convolutional and pooling layers perform feature extraction, while the fully connected layer maps the extracted features to the final output, such as performing classification.

The neural network, such as CNN, may be trained in a way that minimizes output errors. In addition to the forward propagation process, which extracts values from the input layer to the output layer, backpropagation occurs in the neural network to calculate an error between the input training data and the output value of the neural network in response thereto and update the weights for the nodes of each layer to reduce the error. The training process in a convolutional neural network can be summarized as the process of finding a kernel that extracts the output value having the least error, based on the given training data. The kernel is the only parameter that is automatically learned during the training process of the convolutional layer. On the other hand, the kernel size, number of kernels, padding, etc. in a convolutional neural network are hyperparameters that should be configured before starting the training process, and therefore, different convolutional neural network models may be categorized based on differences in kernel size, number of kernels, and the number of convolutional and pooling layers.

The neural network may be trained by at least one of supervised learning using learning data to which a correct answer is labeled, unsupervised learning using learning data to which a correct answer is unlabeled, semi-supervised learning, or reinforcement learning. At this time, an error may be calculated by comparing the output via the neural network with the label or training data, and the calculated error is backpropagated in the reverse direction (i.e., from the output layer to the input layer) in the neural network, and the connection weights of nodes in each layer of the neural network may be updated according to the backpropagation. The amount of change in the connection weights of each node to be updated may be determined according to a learning rate.

Overfitting is a phenomenon in which excessive training on the training data causes the error to increase even as the number of learning iterations increases. Overfitting may cause errors in machine learning algorithms to increase, and various optimization methods may be used to prevent overfitting. To prevent overfitting, methods such as increasing training data, regularization, dropout that deactivates some of nodes in the network during a training process, and utilizing batch normalization layers may be applied.

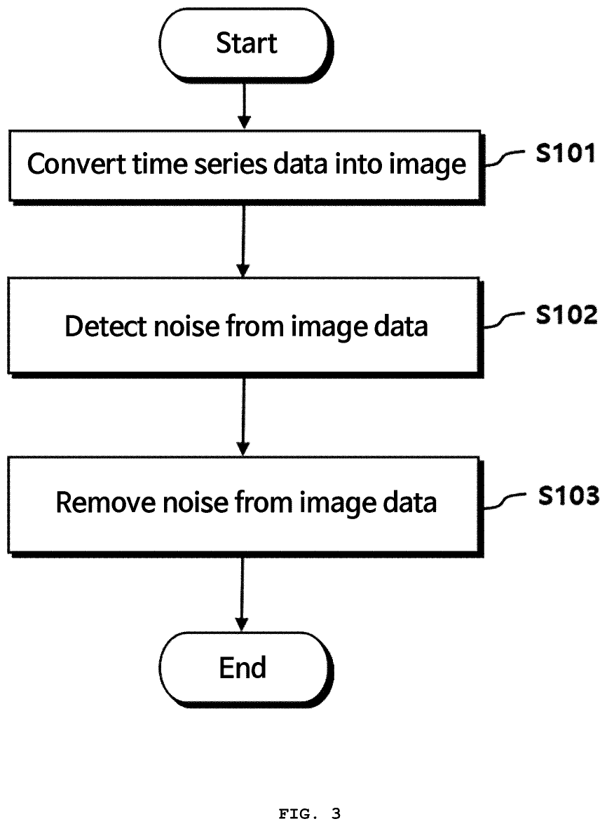

FIG. 3 is a block diagram illustrating a process for removing a motion artifact of a functional near-infrared spectroscopy signal according to an embodiment of the disclosure.

Referring to FIG. 3, a computing device for removing a motion artifact a of functional near-infrared spectroscopy signal according to an embodiment may convert time series data of a functional near-infrared spectroscopy signal measured from a subject via multiple channels into image data (S101), determine whether noise is present in the converted image data using a pretrained detection model (S102), and remove, using a pretrained noise removal model, noise from image data in which noise has been detected (S103).

The computing device may convert, when converting time series data of functional near-infrared spectroscopy signals measured from a subject via multiple channels into image data, the time series data into polar coordinates. For example, the computing device may convert the time series data into polar coordinates according to Equation 1 below.

$$\begin{matrix}{ϕ}_{i} = arccos ( {x}_{i} ) \\ {r}_{i} = \frac{i}{N}\end{matrix} \qquad [ Equation 1 ]$$

wherein N denotes the number of timestamps in time series data, and xᵢ represents the functional near-infrared spectroscopy signal value at a specific timestamp i.

The computing device may convert, when converting time series data of functional near-infrared spectroscopy signals measured from a subject via multiple channels into image data, the time series data into a gramian angular summation field (GASF) image according to Equation 2 below to thereby convert the time series data into image data.

$$G = ( \begin{matrix}cos ( {ϕ}_{1} + {ϕ}_{1} ) & cos ( {ϕ}_{1} + {ϕ}_{2} ) & ⋯ & cos ( {ϕ}_{1} + {ϕ}_{n} ) \\ cos ( {ϕ}_{2} + {ϕ}_{1} ) & cos ( {ϕ}_{2} + {ϕ}_{2} ) & ⋯ & cos ( {ϕ}_{2} + {ϕ}_{n} ) \\ ⋮ & ⋮ & ⋱ & ⋮ \\ cos ( {ϕ}_{n} + {ϕ}_{1} ) & cos ( {ϕ}_{n} + {ϕ}_{2} ) & ⋯ & cos ( {ϕ}_{n} + {ϕ}_{n} )\end{matrix} ) \qquad [ Equation 2 ]$$

wherein φᵢ is the arccosine value of the functional near-infrared spectroscopy (fNIRS) signal value at a specific timestamp i.

The computing device may classify the type of noise from the converted image data when determining whether noise is present in the converted image data by using a pretrained detection model. At this time, the processor 100 may classify the type of noise from the converted image data as a spike or a baseline shift.

The computing device may normalize the time series data of the functional near-infrared spectroscopy signals.

When removing, using a pre-learned noise removal model, noise from the image data in which noise has been detected, the computing device may generate image data from which noise is removed from the image data.

When removing, using a pretrained noise removal model, noise from the image data in which noise has been detected, the computing device may select, using the pre-learned noise removal model, a removal filter according to the type of noise from the image data in which noise has been detected.

When removing, using a pre-learned noise removal model, noise from the image data in which noise has been detected, the computing device may reconstruct time series data from the noise-removed image data.

The computing device may utilize, when removing motion artifacts of functional near-infrared spectroscopy signals measured via multiple channels, time series data of the functional near-infrared spectroscopy signal. In addition, the computing device may detect, when removing noise from the image data in which noise has been detected, noise by comparing image data respectively converted from time series data measured by adjacent channels.

Hereinafter, the disclosure will be described in more detail by the following examples. However, these examples are only for illustrating the disclosure, and the scope of the disclosure is not limited by these examples.

### Example 1: Detection of Motion Artifacts of Functional Near-Infrared Spectroscopy Signals Using Convolutional Neural Networks

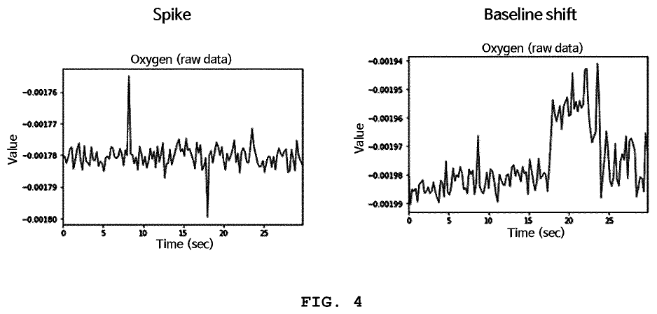

Motion artifacts were induced from the fNIRS device. Specifically, to generate motion artifacts, the subject was instructed to perform tasks such as raising their eyebrows, shaking their heads left and right, tilting their heads left and right, moving their upper body left and right, and rapidly shaking their heads left and right, and signal data containing motion artifacts were acquired as shown in FIG. 4.

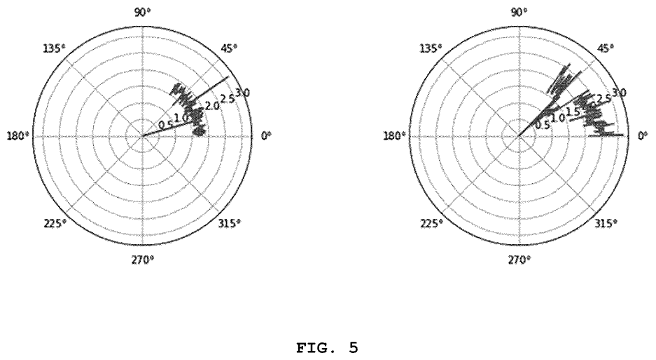

Afterwards, the acquired time series data was adjusted to the data value range of [−1, 1] by Min-Max normalization, and the near-infrared spectroscopy signal value at each time point was calculated as the arccosine value, as shown in FIG. 5 according to Equation 1 below.

$$\begin{matrix}{ϕ}_{i} = arccos ( {x}_{i} ) \\ {r}_{i} = \frac{i}{N}\end{matrix} \qquad [ Equation 1 ]$$

wherein N denotes the number of timestamps in time series data, and xᵢ represents the functional near-infrared spectroscopy signal value at a specific timestamp i.

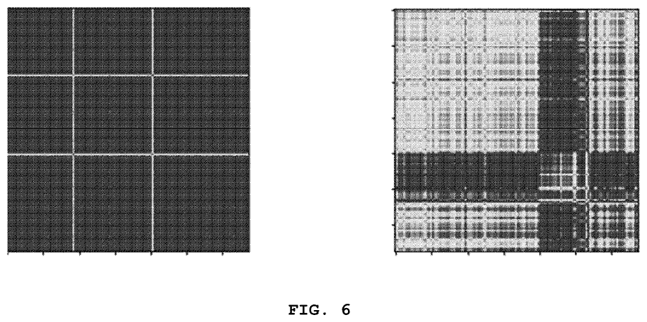

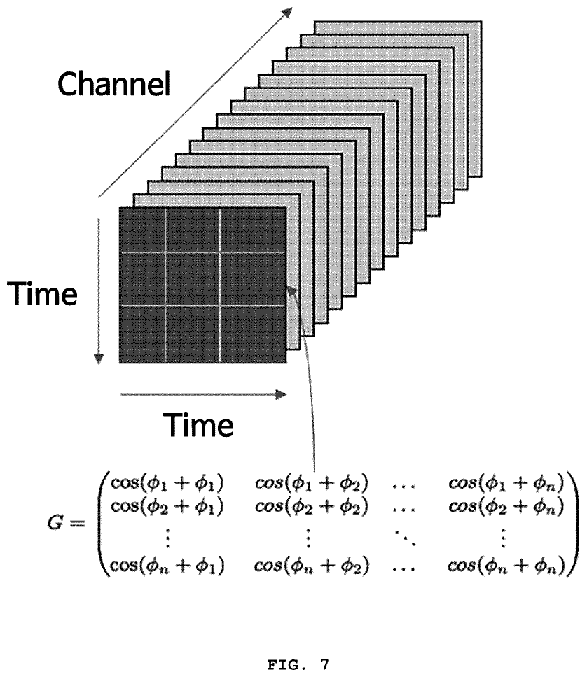

Subsequently, the acquired polar coordinate values were substituted into the Gram matrix according to Equation 2 and calculated, and then the GASF array data calculated based on a “jet” type colorbar was converted into images as shown in FIGS. 6 and 7.

$$G = ( \begin{matrix}cos ( {ϕ}_{1} + {ϕ}_{1} ) & cos ( {ϕ}_{1} + {ϕ}_{2} ) & ⋯ & cos ( {ϕ}_{1} + {ϕ}_{n} ) \\ cos ( {ϕ}_{2} + {ϕ}_{1} ) & cos ( {ϕ}_{2} + {ϕ}_{2} ) & ⋯ & cos ( {ϕ}_{2} + {ϕ}_{n} ) \\ ⋮ & ⋮ & ⋱ & ⋮ \\ cos ( {ϕ}_{n} + {ϕ}_{1} ) & cos ( {ϕ}_{n} + {ϕ}_{2} ) & ⋯ & cos ( {ϕ}_{n} + {ϕ}_{n} )\end{matrix} ) \qquad [ Equation 2 ]$$

wherein φᵢ is the arccosine value of the functional near-infrared spectroscopy (fNIRS) signal at a specific timestamp i.

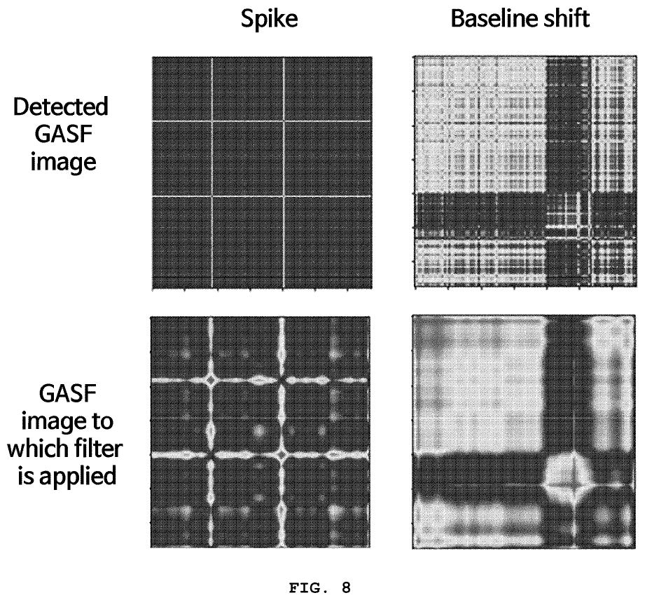

After that, as noted from FIG. 8, noise detection was performed using a motion artifact detection deep learning model, and the model was trained after labeling data without motion artifact and data with motion artifact (abnormal spikes and baseline shifts). Using the deep learning model, the data were classified into three categories including data without noise, motion artifact exhibiting abnormal spikes, and motion artifact showing baseline shifts.

The image was applied to the motion artifact removal deep learning model to remove a motion artifact therefrom. The motion artifact removal model was trained using two-dimensional noise removal filters and data containing noise, and different removal filters were applied depending on the type of noise to effectively remove noise.

### Example 2: Comparison with Existing Noise Detection Methods

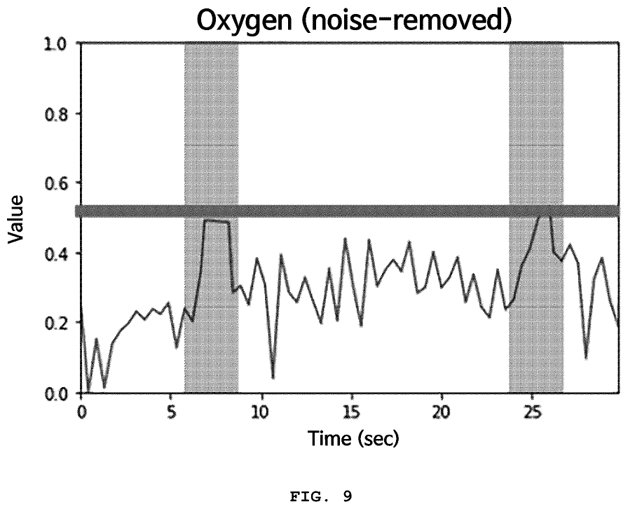

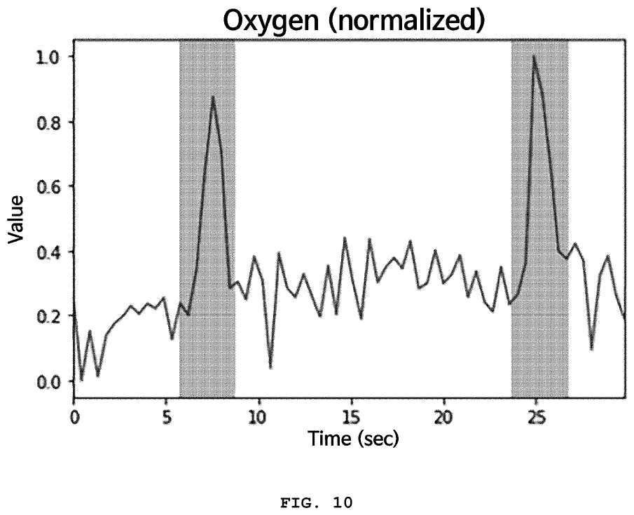

Existing motion artifact detection was performed using previously acquired fNIRS data having motion artifacts. As shown in FIG. 9, in the existing motion artifact detection, when the acquired signal data deviates from a certain value as a standard, the acquired signal data was considered to motion artifacts, and the data was adjusted to a range value of 0 to 1 via Min-Max normalization, and the values greater than “0.5” as a standard were detected and removed as motion artifacts, as illustrated in FIG. 10.

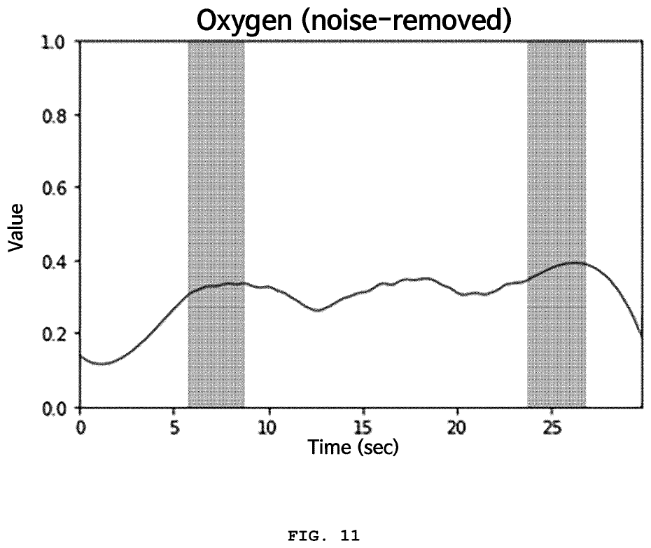

Subsequently, the one-dimensional time-series data obtained via the existing motion artifact detection and removal method and the motion artifact removal method of Example 1, as shown in FIG. 11, were compared based on the signal-to-noise ratio (SNR). The experimental results identified that the SNR of the proposed method was higher than that of the existing method.

### INDUSTRIAL APPLICABILITY

Accordingly, the inventors of the disclosure have developed a method for detecting and removing motion artifacts of functional near-infrared spectroscopy (fNIRS) signals, based on an artificial neural network model, and have identified that the motion artifact detection and removal performance thereof is significantly superior.

Accordingly, an aspect of the disclosure is to provide a method for removing motion artifacts of functional near-infrared spectroscopy signals.

Another aspect of the disclosure is to provide a computer program for removing motion artifacts of functional near-infrared spectroscopy signals.

Yet another aspect of the disclosure is to provide a computing device for removing motion artifacts of functional near-infrared spectroscopy signals.

1. A method for removing, by a computing device, a motion artifact of a functional near-infrared spectroscopy (fNIRS) signal, the method comprising:
a conversion step of converting time series data of a functional near-infrared spectroscopy signal measured from a subject via a plurality of channels into image data;
a detection step of determining, using a pretrained detection model, whether noise is present in the converted image data; and
a removal step of removing, using a pretrained noise removal model, noise from the image data in which noise is detected.

2. The method of claim 1, wherein the conversion step comprises a coordinate conversion step of converting time series data into polar coordinates according to Equation 1 below,
$$\begin{matrix}{ϕ}_{i} = arccos ( {x}_{i} ) \\ {r}_{i} = \frac{i}{N}\end{matrix} \qquad [ Equation 1 ]$$
wherein N denotes the number of timestamps in the time series data, and
wherein xᵢ represents a functional near-infrared spectroscopy signal value at a specific timestamp i.

3. The method of claim 1, wherein the conversion step comprises a gramian angular summation field (GASF) image generation step of converting time series data into a GASF image according to Equation 2 below to thereby convert the time series data into image data,
$$G = ( \begin{matrix}cos ( {ϕ}_{1} + {ϕ}_{1} ) & cos ( {ϕ}_{1} + {ϕ}_{2} ) & ⋯ & cos ( {ϕ}_{1} + {ϕ}_{n} ) \\ cos ( {ϕ}_{2} + {ϕ}_{1} ) & cos ( {ϕ}_{2} + {ϕ}_{2} ) & ⋯ & cos ( {ϕ}_{2} + {ϕ}_{n} ) \\ ⋮ & ⋮ & ⋱ & ⋮ \\ cos ( {ϕ}_{n} + {ϕ}_{1} ) & cos ( {ϕ}_{n} + {ϕ}_{2} ) & ⋯ & cos ( {ϕ}_{n} + {ϕ}_{n} )\end{matrix} ) \qquad [ Equation 2 ]$$
wherein φᵢ is an arccosine value of a functional near-infrared spectroscopy (fNIRS) signal value at a specific timestamp i.

4. The method of claim 1, wherein the detection step comprises a classification step of classifying a type of noise from the converted image data.

5. The method of claim 1, further comprising a normalization step of normalizing the time series data of the functional near-infrared spectroscopy signal.

6. The method of claim 1, wherein the removal step comprises a reconstruction step of reconstructing the image data, from which noise is removed, into time series data.

7. The method of claim 1, wherein the detection model is subjected to supervised training, based on at least one training image and a guide label corresponding to the training image and comprising a noise determination result, and
wherein the supervised training is performed based on a result of comparing the guide label with training information generated for the training image by using the detection model.

8. The method of claim 7, wherein the supervised training is performed based on a result value calculated by substituting the training information and the guide label into a binary cross-entropy loss function.

9. The method of claim 1, wherein the removal step comprises a selection step of selecting, through a pretrained noise removal model, a removal filter according to a type of noise from the image data in which noise is detected.

10. The method of claim 1, wherein each of the detection model and the noise removal model is a deep neural network (DNN) model.

11. The method of claim 10, wherein the deep neural network model comprises a convolutional neural network (CNN) model.

12. The method of claim 1, wherein the detection step comprises a comparison step of detecting noise by comparing image data converted from respective time series data measured via adjacent channels.

13. A computer program stored in a storage medium,
wherein the computer program, when executed on one or more processors, causes operations for removing a motion artifact of a functional near-infrared spectroscopy (fNIRS) signal to be performed, the operations comprising:
a conversion operation of converting time series data of a measured functional near-infrared spectroscopy signal into image data;
a detection operation of determining, using a pretrained detection model, whether noise is present in the converted image data; and
a removal operation of removing, using a pretrained noise removal model, noise from the image data in which noise is detected.

14. A computing device for removing a motion artifacts of a functional near-infrared spectroscopy (fNIRS) signal, the computing device comprising a processor including one or more cores, and a memory,
wherein the processor is configured to:
convert time series data of a measured functional near-infrared spectroscopy signal into image data;
determine, using a pretrained detection model, whether noise is present in the converted image data; and
remove, using a pretrained noise removal model, noise from the image data in which noise is detected.
